(19) United States
(12) Patent Application Publication
(10) Pub. No.: US 2026/0095874 A1
(43) Pub. Date: Apr. 2, 2026

(54) WIRELESS TERMINAL TEST DEVICE AND TIMING MISALIGNMENT DISPLAY METHOD FOR THE SAME

(71) Applicant: ANRITSU CORPORATION, Kanagawa (JP)

(72) Inventors: Shigeharu ARAI, Kanagawa (JP); Takayuki KOGUCHI, Kanagawa (JP); Katsuo SAKURAI, Kanagawa (JP); Kengo KIKUCHI, Kanagawa (JP)

(21) Appl. No.: 19/272,402

(22) Filed: Jul. 17, 2025

(30) Foreign Application Priority Data
Sep. 30, 2024 (JP) 2024-170451

(51) Int. Cl. H04W 56/00; H04W 74/0833; H04W 84/06

(52) U.S. Cl. CPC H04W 56/001; H04W 74/0833; H04W 84/06

(57) ABSTRACT

A delay addition unit that adds a propagation delay of a signal in a case of being via a satellite, which is calculated from position information of the satellite and UE, to an uplink signal from the UE and outputs the signal, a timing generation unit that generates a downlink signal and synchronizes with the UE, a power measurement unit that measures power of the uplink signal received from the UE, a reception processing unit that performs a reception process of the received uplink signal, a heat map generation unit that displays a power measurement value measured by the power measurement unit on a heat map in which the power measurement value is arranged in time series, on a display unit, and a timing misalignment detection unit that displays a position of an NPRACH of a 3GPP standard in a superimposed manner on the heat map.

### [Technical Field]

The present invention relates to a wireless terminal test device that simulates a base station of a wireless communication system to test a wireless terminal.

### [Background Art]

In a case where a wireless terminal, such as an Internet of Things (IoT) terminal, that uses wireless communication for network connection is developed, it is necessary to test whether or not the developed wireless terminal can normally perform communication. Therefore, a test in which a wireless terminal to be tested is connected to a test device that operates as a simulated base station that simulates a function of an actual base station, communication is performed between the test device and the wireless terminal, and content of the communication is checked is performed.

A narrowband Internet of Things (NB-IoT) is standardized as communication means of the IoT terminal. In addition, a non-terrestrial network (NTN) that is a non-ground network using a satellite, which can be used in the NB-IoT, is also defined.

Patent Document 1 describes that in the NTN, uplink synchronization is executed by appropriately setting a timing advance (TA) between an airborne base station and a terminal.

### [Related art Document]

### [Patent Document]

[Patent Document 1] WO2023/013008

### [Disclosure of the Invention]

### [Problem that the Invention is to Solve]

In a case where the communication of a wireless terminal of the NB-IoT via the NTN is simulated, a satellite is inserted between the base station and the wireless terminal, and thus a larger propagation delay occurs as compared with a case of communication on the ground.

On a base station side, since there is no means for accurately measuring a propagation delay amount between the wireless terminal and the satellite, an uplink signal is received by a propagation delay amount calculated from position information of the wireless terminal and the satellite.

It is assumed that it is difficult to align a timing because a range of timing search of the uplink signal is within ±100 μs and is much narrower than the propagation delay amount.

Therefore, an object of the present invention is to provide a wireless terminal test device that can easily perform timing alignment of an uplink signal by making it easy to understand a difference in the timing of the uplink signal.

### Means for solving the problem

A wireless terminal test device according to the present invention is a wireless terminal test device (1) that simulates communication with a wireless terminal (100) via a satellite to perform a test for the wireless terminal, the wireless terminal test device includes: a display unit (18) that displays a misalignment between a period in which power of an uplink signal from the wireless terminal is large and a period corresponding to a timing position of a narrowband physical random access channel (NPRACH).

With this configuration, the misalignment between the period in which the power of the uplink signal is large and the period corresponding to the timing position of the NPRACH is displayed. Therefore, it is possible to easily understand a difference in a timing of the uplink signal, and to easily perform timing alignment of the uplink signal.

In addition, in the wireless terminal test device according to the present invention, the period corresponding to the timing position of the NPRACH is displayed with a frame line on a heat map in which a power value of the uplink signal for each predetermined time is arranged in time series.

With this configuration, the period corresponding to the timing position of the NPRACH is displayed with the frame line on the heat map in which the power value of the uplink signal for each predetermined time is arranged in time series. Therefore, it is possible to easily understand the difference in the timing of the uplink signal, and to easily perform the timing alignment of the uplink signal.

In addition, in the wireless terminal test device according to the present invention, the heat map is displayed differently between the period in which the power of the uplink signal is large and another period.

With this configuration, the period in which the power of the uplink signal is large and another period on the heat map are displayed in different shapes. Therefore, it is possible to easily understand the difference in the timing of the uplink signal, and to easily perform the timing alignment of the uplink signal.

In addition, a timing misalignment display method according to the present invention is a timing misalignment display method for a wireless terminal test device (1) that simulates communication with a wireless terminal (100) via a satellite to perform a test for the wireless terminal, the timing misalignment display method includes: a step of displaying, on a display unit (18), a heat map in which a power value of an uplink signal from the wireless terminal for each predetermined time is arranged in time series; and a step of displaying a period corresponding to a timing position of an NPRACH with a frame line on the heat map.

In addition, the timing misalignment display method according to the present invention further includes: a step of displaying the heat map differently between the period in which power of the uplink signal is large and another period.

With this configuration, the period corresponding to the timing position of the NPRACH is displayed with the frame line on the heat map in which the power value of the uplink signal for each predetermined time is arranged in time series. Therefore, it is possible to easily understand the difference in the timing of the uplink signal, and to easily perform the timing alignment of the uplink signal.

### [Advantage of the Invention]

The present invention can provide a wireless terminal test device that can easily perform timing alignment of an uplink signal by making it easy to understand a difference in the timing of the uplink signal.

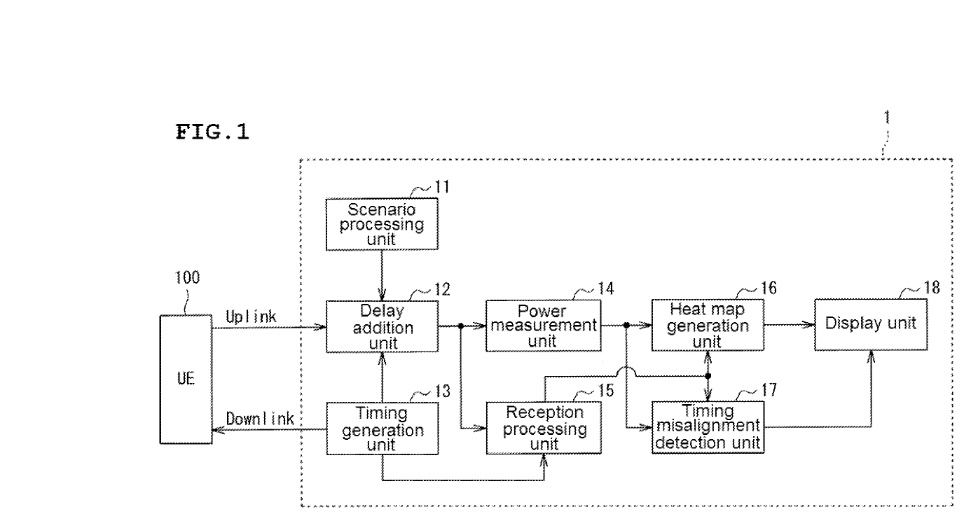

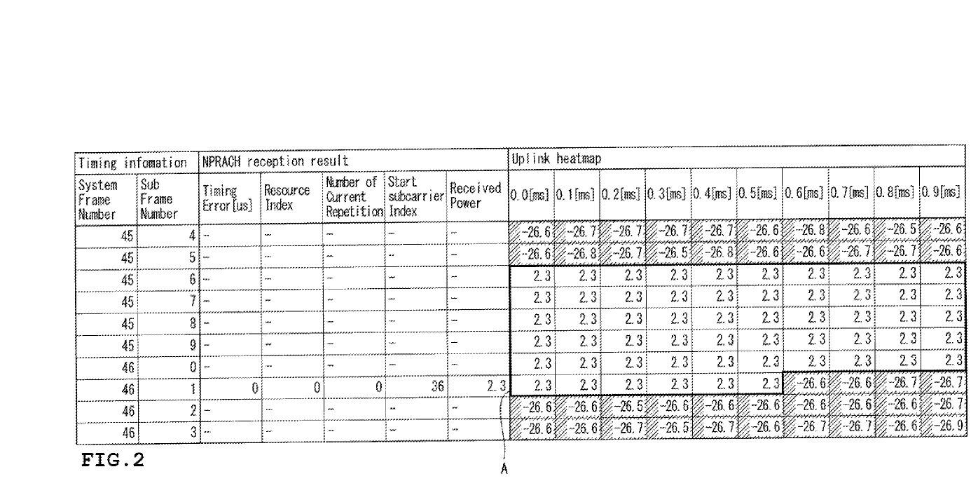

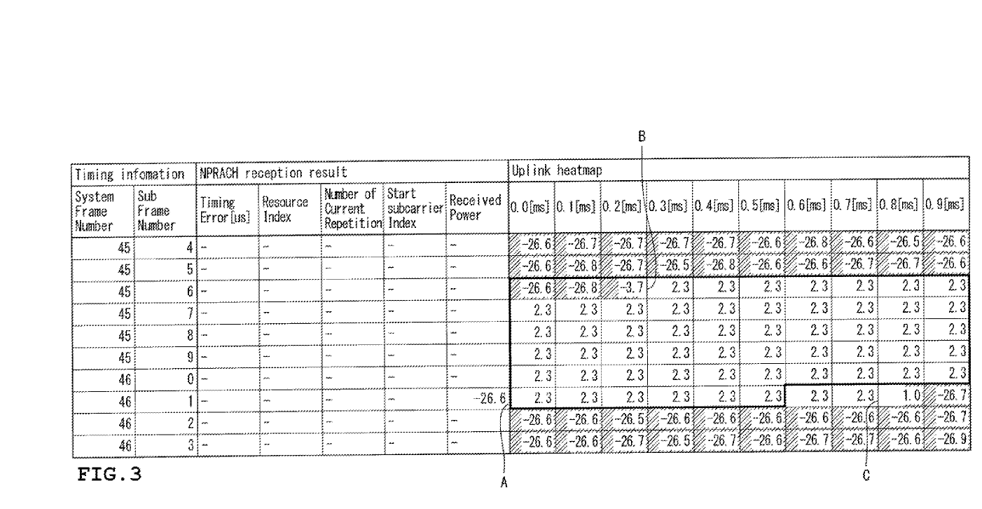

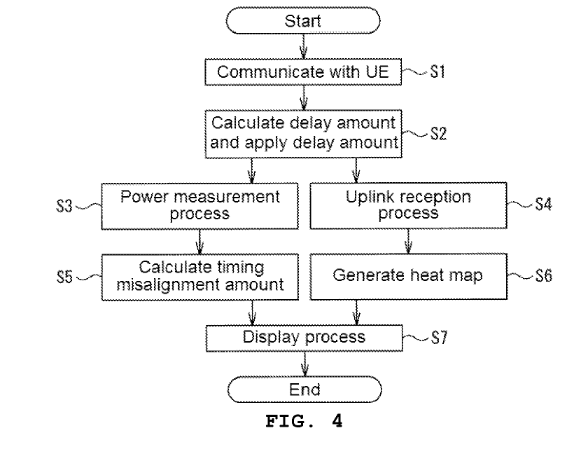

### [Brief Description of the Drawings]

[FIG. 1] FIG. 1 is a block diagram showing a wireless terminal test device according to an embodiment of the present invention.

[FIG. 2] FIG. 2 is a diagram showing an example of a heat map and timing positions of an NPRACH in a case where timings of the wireless terminal test device according to the embodiment of the present invention coincide with each other.

[FIG. 3] FIG. 3 is a diagram showing an example of the heat map and the timing positions of the NPRACH in a case where the timings of the wireless terminal test device according to the embodiment of the present invention do not coincide with each other.

[FIG. 4] FIG. 4 is a flowchart illustrating a procedure of a timing misalignment display process of the wireless terminal test device according to the embodiment of the present invention.

### [Best Mode for Carrying Out the Invention]

Hereinafter, a wireless terminal test device according to an embodiment of the present invention will be described in detail with reference to the drawings.

In FIG. 1, a wireless terminal test device 1 according to the embodiment of the present invention is connected to user equipment (UE) 100 as a wireless terminal in a wired manner via a coaxial cable or the like, and performs a measurement test by simulating a base station and transmitting a radio frequency (RF) signal to and receiving an RF signal from the UE 100.

The wireless terminal test device 1 includes a scenario processing unit 11, a delay addition unit 12, a timing generation unit 13, a power measurement unit 14, a reception processing unit 15, a heat map generation unit 16, a timing misalignment detection unit 17, and a display unit 18.

The scenario processing unit 11 creates a scenario for simulating the base station based on a setting for simulating the base station input from a user, and simulates the base station based on the scenario. In a case of performing a test of communication via a NTN, position information of a satellite and the UE 100 is set in the scenario.

The delay addition unit 12 adds a propagation delay amount of a signal in a case of being transmitted via the satellite, which is calculated from the position information of the satellite and the UE 100 set in the scenario, to an uplink signal from the UE 100 and outputs the signal. The delay amount is about 500 msec at the maximum.

The timing generation unit 13 generates a Subframe timing having a cycle of 1 msec and the like, generates a downlink signal in synchronization with the Subframe timing, synchronizes with the UE 100, and enables the reception processing unit 15 to receive the uplink signal.

The power measurement unit 14 measures power of the uplink signal received from the UE 100. The power measurement unit 14 measures, for example, the power of a signal of the uplink signal in units of 0.1 ms and outputs a result.

The reception processing unit 15 performs a reception process such as a timing synchronization process and a demodulation process of the received uplink signal, and outputs a signal subjected to the reception process, timing information of the received signal, and the like.

The heat map generation unit 16 displays a power measurement value measured by the power measurement unit 14 on a heat map in which the power measurement values are arranged in time series, on the display unit 18 based on the output of the power measurement unit 14 and the reception processing unit 15, and displays a period in which the power measurement value is large in a color different from those of other periods.

The timing misalignment detection unit 17 displays a position of a narrowband physical random access channel (NPRACH) of a 3rd generation partnership project (3GPP) standard from the timing information of the received signal or the like, in a superimposed manner on the heat map generated and displayed by the heat map generation unit 16 by surrounding the position in a frame in a color or a form different from those of other frames, based on the output of the power measurement unit 14 and the reception processing unit 15. A start position of the NPRACH is determined based on a transmission timing of the downlink signal, and an end position is determined by the 3GPP standard.

The display unit 18 includes an image display device such as a liquid crystal display, and displays an image or the like generated by the heat map generation unit 16, the timing misalignment detection unit 17, or the like.

Here, the wireless terminal test device 1 includes a computer device (not shown) provided with a communication module for communicating with the UE 100. The computer device includes a central processing unit (CPU), a read-only memory (ROM), a random-access memory (RAM), a storage device such as a hard disk device, an input and output port, and a touch panel (none of which is shown).

A program for causing the computer device to function as the wireless terminal test device 1 is stored in the ROM and the hard disk device of the computer device. That is, the computer device functions as the wireless terminal test device 1 by the CPU executing the program stored in the ROM by using the RAM as a work area.

As described above, in the present embodiment, the scenario processing unit 11, the heat map generation unit 16, and the timing misalignment detection unit 17 are configured by the CPU, and the delay addition unit 12, the timing generation unit 13, the power measurement unit 14, and the reception processing unit 15 are configured by the communication module.

In the wireless terminal test device 1 having such a configuration, the heat map generation unit 16 and the timing misalignment detection unit 17 display, for example, the heat map and a frame line of the timing position of the NPRACH as shown in FIG. 2 on the display unit 18.

In FIG. 2, a "System Frame Number" column of a "Timing information" column indicates the numbers of wireless frames, and a "Sub Frame Number" column indicates the numbers of subframes obtained by dividing one frame into 10 subframes.

A "Timing Error" column in an "NPRACH reception result" column indicates misalignment amounts between the frame line of the timing position of the NPRACH and the period on the heat map in which the power measurement value is large, a "Resource Index" column indicates indices indicating a range of usable coverage, and a "Number of Current Repetition" column indicates the current Repetition number.

In an "Uplink heatmap" column on the right side of the drawing, on the heat map, the power measurement values of the uplink signal for every 0.1 ms are displayed in time series. The period in which the power measurement value is large (a period in which the power measurement value is 2.3) is displayed in a color different from those of other periods (periods in which the power measurement value is negative).

In the heat map, the period corresponding to the timing position of the NPRACH is displayed by being surrounded by a thick frame line different from other frame lines as shown by A in the drawing. The frame line of A in the drawing may be a frame line in a color different from that of other frame lines.

In FIG. 2, the period in which the power measurement value is large and the period corresponding to the timing position of the NPRACH coincide with each other, and the reception of the NPRACH is successful.

FIG. 3 shows a case where the period in which the power measurement value is large and the period corresponding to the timing position of the NPRACH do not coincide with each other.

In FIG. 3, periods indicated by B or C are assumed to be periods in which a value of the power measurement value is not close to a value of adjacent periods and the power measurement value changes from a small value to a large value or from a large value to a small value. Therefore, a portion to be displayed in a different color is displayed by being narrowed in accordance with a ratio of the power measurement value to the power measurement value in the period in which the power measurement value is large.

In the example of FIG. 3, a misalignment between the period in which the power measurement value is large and the period corresponding to the timing position of the NPRACH is about +0.28 ms (delayed by about 0.28 ms from the timing of the 3GPP standard).

As shown in FIG. 3, in a case where the period in which the power measurement value is large and the period corresponding to the timing position of the NPRACH are misaligned from each other, for example, a set value of a TA of the UE 100 is changed and adjustment is performed such that the period in which the power measurement value is large and the period corresponding to the timing position of the NPRACH are misaligned from each other within ±1 slot.

A timing misalignment display process performed by the wireless terminal test device 1 according to the present embodiment configured as described above will be described with reference to FIG. 4. The timing misalignment display process described below is started when a start of the communication with the UE 100 is selected by an operation of the user.

In step S1, the timing generation unit 13 performs a transmission process of the downlink signal as the communication with the UE 100. After the process of step S1 is executed, the delay addition unit 12 executes a process of step S2.

In step S2, the delay addition unit 12 calculates the delay amount from the position information of the satellite and the UE 100 set in the scenario, and adds the delay amount to the received uplink signal and outputs the signal to the power measurement unit 14 and the reception processing unit 15. After the process of step S2 is executed, the power measurement unit 14 executes a process of step S3, and the reception processing unit 15 executes a process of step S4.

In step S3, the power measurement unit 14 measures the power of the signal of the uplink signal for each predetermined time and outputs the result. After the process of step S3 is executed, the timing misalignment detection unit 17 executes a process of step S5.

In step S4, the reception processing unit 15 performs the reception process of the uplink signal. After the process of step S4 is executed, the heat map generation unit 16 executes a process of step S6.

In step S5, the timing misalignment detection unit 17 calculates the position of the NPRACH of the 3GPP standard based on the output of the power measurement unit 14 and the reception processing unit 15. After the process of step S5 is executed, the timing misalignment detection unit 17 executes a process of step S7.

In step S6, the heat map generation unit 16 generates the heat map in which the power measurement value for each predetermined time is arranged in time series based on the output of the power measurement unit 14 and the reception processing unit 15. After the process of step S6 is executed, the heat map generation unit 16 executes the process of step S7.

In step S7, the heat map generation unit 16 displays the heat map on the display unit 18 and displays the period in which the power measurement value is large in a color different from those of other periods, and the timing misalignment detection unit 17 displays the frame line indicating the position of the NPRACH of the 3GPP standard in a superimposed manner on the heat map. After the process of step S7 is executed, the heat map generation unit 16 and the timing misalignment detection unit 17 end the timing misalignment display process.

As described above, in the above-described embodiment, the wireless terminal test device 1 displays the power measurement value on the heat map in which the power measurement value of the signal of the uplink signal for each predetermined time is arranged in time series by differently displaying the period in which the power measurement value is large, and displays the frame line indicating the position of the NPRACH of the 3GPP standard in a superimposed manner on the heat map.

Accordingly, it is possible to easily understand a difference in the timing of the uplink signal, and to easily perform the timing alignment of the uplink signal.

Hitherto, the embodiment of the present invention has been disclosed, but it is clear that changes can be made by those skilled in the art without departing from the scope of the present invention. All such modifications and equivalents are intended to be included in the following claims.

### [Description of Reference Numerals and Signs]

1: wireless terminal test device

11: scenario processing unit

12: delay addition unit

13: timing generation unit

14: power measurement unit

15: reception processing unit

16: heat map generation unit

17: timing misalignment detection unit

18: display unit

100: UE (wireless terminal)

What is claimed is:

1. A wireless terminal test device that simulates communication with a wireless terminal via a satellite to perform a test for the wireless terminal, the wireless terminal test device comprising:
a display unit that displays a misalignment between a period in which power of an uplink signal from the wireless terminal is large and a period corresponding to a timing position of an NPRACH.

2. The wireless terminal test device according to claim 1,
wherein the period corresponding to the timing position of the NPRACH is displayed with a frame line on a heat map in which a power value of the uplink signal for each predetermined time is arranged in time series.

3. The wireless terminal test device according to claim 2,
wherein the heat map is displayed differently between the period in which the power of the uplink signal is large and another period.

4. A timing misalignment display method for a wireless terminal test device that simulates communication with a wireless terminal via a satellite to perform a test for the wireless terminal, the timing misalignment display method comprising:
a step of displaying, on a display unit, a heat map in which a power value of an uplink signal from the wireless terminal for each predetermined time is arranged in time series; and
a step of displaying a period corresponding to a timing position of an NPRACH with a frame line on the heat map.

5. The timing misalignment display method according to claim 4, further comprising:
a step of displaying the heat map differently between the period in which power of the uplink signal is large and another period.
